(19) United States
(12) Patent Application Publication
(10) Pub. No.: US 2026/0085435 A1
(43) Pub. Date: Mar. 26, 2026

(54) DEVICE FOR SUPPLYING A DIRECT CURRENT TO ELECTROLYSIS CELLS

(71) Applicant: Siemens Energy Global GmbH & Co. KG, München (DE)

(72) Inventors: Mario Schenk, Herzogenaurach (DE); Jörg Dorn, Buttenheim (DE); Sebastian Semmler, Nürnberg (DE); Wolfgang Hörger, Hausen (DE); Andreas Philipp, Winkelhaid (DE); Peter Utz, Nürnberg (DE)

(21) Appl. No.: 19/112,672

(22) PCT Filed: Sep. 21, 2022
(86) PCT No.: PCT/EP2022/076228

§ 371 Date: Mar. 18, 2025

(51) Int. Cl. C25B 9/65; C25B 9/70; H01F 27/28

(52) U.S. Cl. CPC C25B 9/65; C25B 9/70; H01F 27/28

(57) ABSTRACT

A device for supplying a direct current to electrolysis cells. The electrolysis cells are arranged in a plurality of electrolysis cell lines. Each electrolysis cell line has a series circuit formed of a plurality of electrolysis cells. The device has a transformer with a primary winding and a number of secondary windings, and the device also has a number of rectifier units. Each secondary winding is electrically connected to the input of one of the rectifier units, and the output of each of the rectifier units is electrically connected to one of the electrolysis cell lines.

The invention relates to a device and a method for supplying a direct current to electrolysis cells.

Electrolysis systems usually have a plurality of electrolysis cells by means of which hydrogen and oxygen may be obtained from water, for example. As such, the electrolysis cells are interconnected in multiple series circuits, each series circuit forming an electrolysis cell line.

An object of the invention is to specify a device and a method for supplying a direct current to electrolysis cells, which are versatile.

According to the invention, this object is achieved by a device and by a method according to the independent patent claims. Advantageous embodiments of the device and the method are specified in the dependent patent claims.

Disclosed is a device for supplying a direct current to electrolysis cells, wherein the electrolysis cells are arranged in multiple electrolysis cell lines, and each electrolysis cell line has a (electric) series circuit consisting of multiple electrolysis cells, wherein
the device has a transformer with a primary winding and a number of secondary windings (in particular electrically isolated from one another),
the device has a number of rectifier units, wherein each secondary winding is electrically connected to an input of one of the rectifier units, and
an output of each of the rectifier units is electrically connected to one of the electrolysis cell lines.

This device for supplying a direct current is advantageously versatile as each electrolysis cell line is provided with a (in particular dedicated) secondary winding and a dedicated rectifier unit. Thus, it is a modular device for supplying a direct current. In this way, the device for supplying a direct current may be easily adapted to a different number of electrolysis cell lines, in particular when expanding an already existing electrolysis system with additional electrolysis cell lines. Thus, the device is readily scalable.

The device may be configured such that
the secondary windings are galvanically isolated from one another. This enables a simple modular structure, even for different numbers of electrolysis cell lines.

The device may be configured such that
each secondary winding is associated with a (in particular dedicated) rectifier unit. Thus, the number of the rectifier units is at least as large as the number of the secondary windings. This also enables a modular structure of the device for supplying a direct current.

The device may be configured such that
the transformer has at least 4, in particular at least 10, secondary windings. In particular, the transformer is a multi-secondary-winding transformer. This enables a larger number of electrolysis cell lines to be supplied with electrical energy (here: with direct voltage and direct current) by one transformer.

The device may be configured such that
the secondary windings each substantially have a secondary voltage of the same amplitude. Thus, the secondary windings may be configured such that they each substantially provide the secondary voltage of the same amplitude. This simplifies the practical implementation of the device.

The device may be configured such that
each of the secondary windings has a different phase shift relative to the primary winding. In other words, all secondary windings have a different phase position. Thus, the phase shifts or phase positions of all secondary windings are different from one another. Advantageously, this causes comparatively low grid perturbations during operation of the device, in particular, comparatively little harmonics are created. Therefore, corrective measures (e.g., filters for filtering out the harmonics) are not or rarely needed.

The device may be configured such that
the rectifier units each have non-controlled or controlled power semiconductor elements, in particular diodes, thyristors, IGBTs or MOSFETs. As such, the rectifier units may be configured as line-commutated rectifier units, then having diodes or thyristors, in particular. The rectifier units may also be configured as self-commutated rectifier units, then having IGBTs or MOSFETs, in particular. In this way, the rectifier units can be adapted to different requirements.

The device may be configured such that
the power semiconductor elements are power semiconductor elements based on silicon carbide (SIC) or gallium nitride (GaN). In this way, comparatively inexpensive rectifier units may be implemented which only have low electrical losses.

The device may be configured such that
a step-up converter or a step-down converter is connected between the output of at least one, in particular all, of the rectifier units and the respective electrolysis cell line. In this way, the direct voltage applied to the electrolysis cell lines may be varied and adapted to different circumstances even more widely.

The device may be configured such that
a disconnecting switch and/or a grounding switch is arranged between at least one, in particular all, of the secondary windings and the respective input of the rectifier unit. In particular, a combined disconnecting/grounding means may be arranged. This simplifies maintenance of an electrolysis cell line which is not in operation, for example.

The device may be configured such that
the outputs are connected in parallel to multiple rectifier units, and the outputs (of these rectifier units) connected in parallel are connected to an electrolysis cell line. In this way, larger direct currents can be provided for the electrolysis cells with uniform/identical rectifier units. As such, the inputs of the rectifier units may each be connected to a dedicated secondary winding. Alternatively, the inputs of the rectifier units may be connected to a common secondary winding. In the latter case in particular, decoupling elements, such as inductors, may be provided to attenuate transients between the rectifier units.

The device may be configured such that
the outputs of multiple rectifier units are connected in a series circuit, and this series circuit is connected to an electrolysis cell line. More specifically, the series circuit of the outputs is electrically connected in series to the electrolysis cell line. Thus, with uniform/identical rectifier units, larger direct voltages can be provided for the respective electrolysis cell line.

Further disclosed is an electrolysis system, having a device for supplying a direct current according to any one of the variations specified above. This electrolysis system has a plurality of electrolysis cells, wherein the electrolysis cells are arranged in multiple electrolysis cell lines, and each electrolysis cell line has a (electric) series circuit consisting of multiple electrolysis cells. Each electrolysis cell line is electrically connected to an output of one of the rectifier units.

Also disclosed is a method for supplying a direct current to electrolysis cells, wherein the electrolysis cells are arranged in multiple electrolysis cell lines, and each electrolysis cell line has a series circuit consisting of multiple electrolysis cells, with a transformer and a number of rectifier units, wherein
the transformer has a primary winding and a number of secondary windings (electrically isolated from one another), and
each secondary winding is electrically connected to an input of one of the rectifier units, wherein, in the method,
one of the electrolysis cell lines each is supplied with direct current from a respective output of one of the rectifier units.

The method may proceed such that
the secondary windings each substantially provide a secondary voltage of the same amplitude.

The device, the electrolysis system and the method have the same or similar properties and/or advantages.

In the following, the invention is explained in greater detail by way of exemplary embodiments. Like reference numerals refer to the same elements or elements of the same effect. To this end,

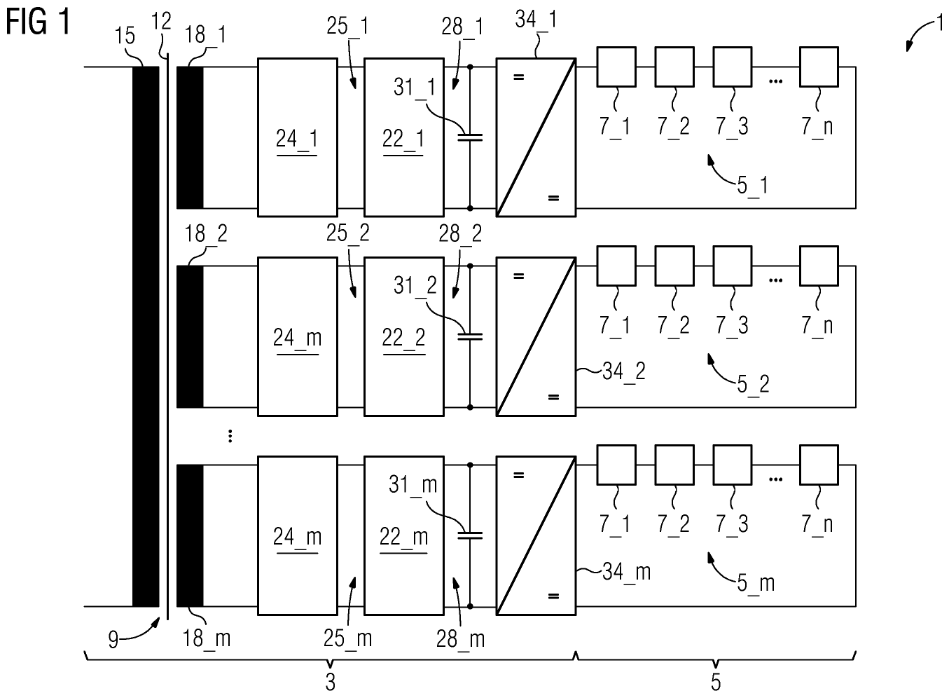

FIG. 1 shows an exemplary embodiment of an electrolysis system,

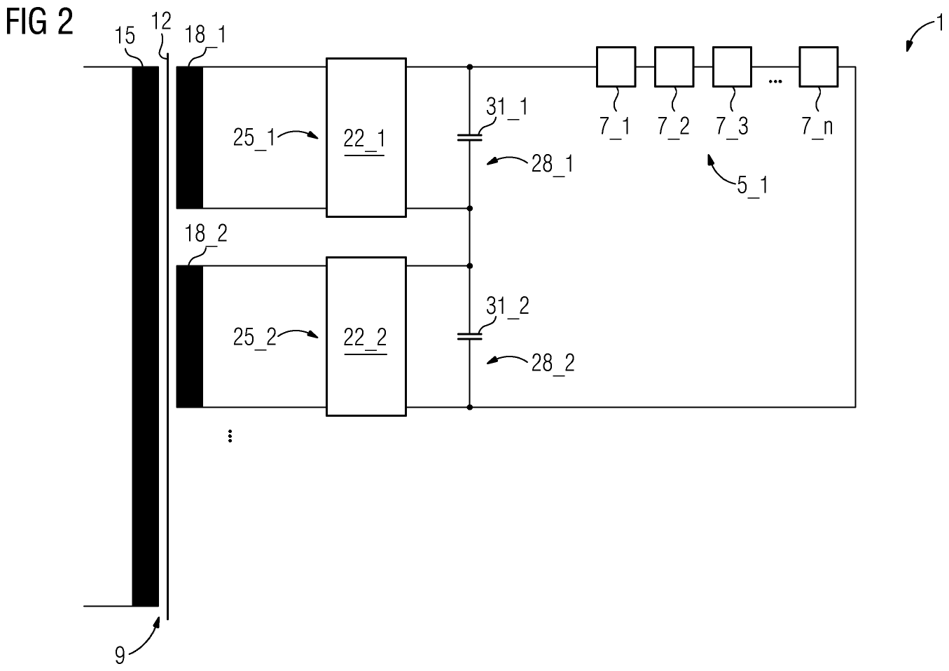

FIG. 2 shows an exemplary embodiment of an electrolysis system in which the outputs of two rectifier units are connected in a series circuit,

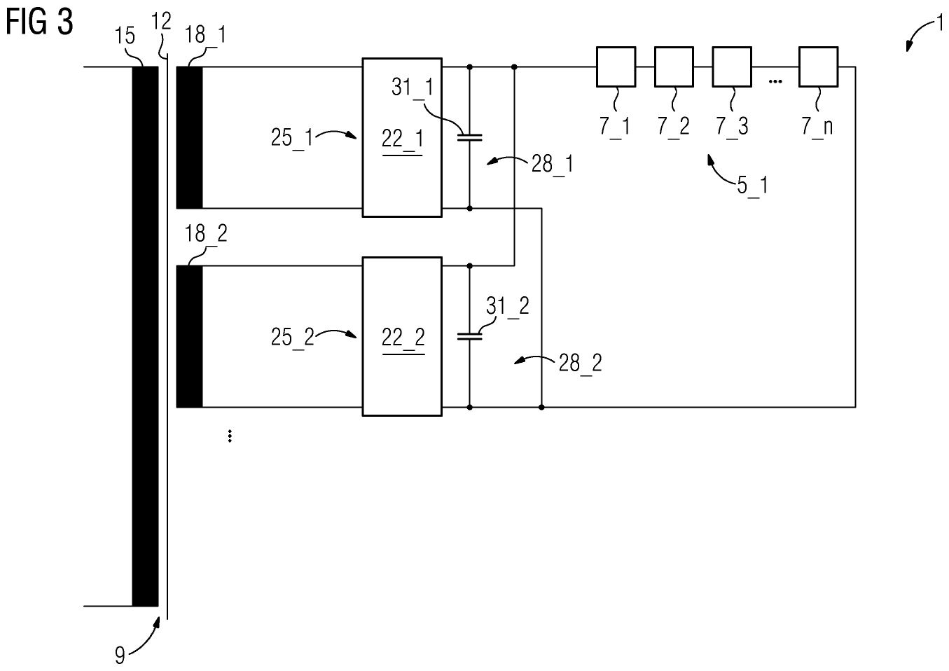

FIG. 3 shows an exemplary embodiment of a part of an electrolysis system in which the outputs of two rectifier units are connected in parallel, and

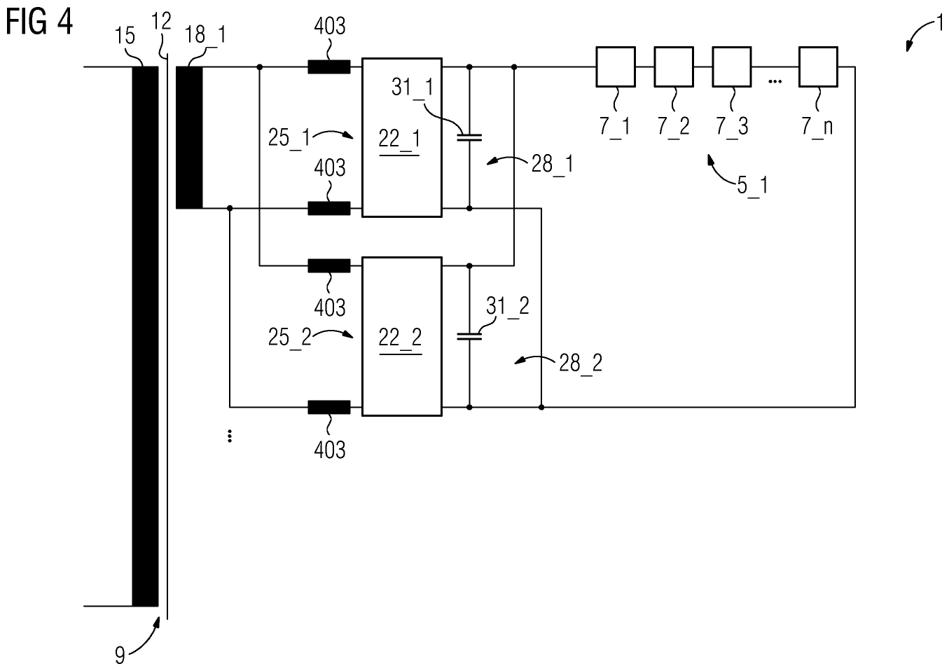

FIG. 4 shows a further exemplary embodiment of a part of an electrolysis system in which the outputs of two rectifier units are connected in parallel.

FIG. 1 shows an exemplary embodiment of an electrolysis system 1. This electrolysis system 1 has a device 3 for supplying a direct current to electrolysis cells and m electrolysis cell lines 5. As such, a first electrolysis cell line 5_1, a second electrolysis cell line 5_2, and an m^{th} electrolysis cell line 5_m are shown. Each electrolysis cell line 5 has a series circuit consisting of multiple electrolysis cells; in the exemplary embodiment, each n electrolysis cells 7_1 to 7_n are electrically connected in series and each form the series circuit.

Device 3 for supplying a direct current has a transformer 9, having a transformer core 12, a primary winding 15 and m secondary windings 18_1 to 18_m. As such, the m secondary windings 18_1 to 18_m are electrically isolated from one another. The m secondary windings 18_1 to 18_m are galvanically isolated from one another.

In general, the transformer has m secondary windings. For example, the transformer may have at least 4 secondary windings, preferably at least 10 secondary windings. However, transformer 9 may also have considerably more secondary windings, for example at least 20, at least 50 or at least 100 secondary windings. The transformer is a multi-secondary-winding transformer.

The m secondary windings 18_1 to 18_m each have substantially one secondary voltage of the same amplitude. Each of secondary windings 18_1 to 18_m has a different phase shift relative to the primary winding. This creates only little harmonics; only low grid perturbations occur. Therefore, corrective measures (e.g., filters) are not or rarely needed, resulting in a cost advantage.

Each secondary winding 18 of the transformer is associated with a (dedicated) rectifier unit 22. Each rectifier unit 22 has an input 25 and an output 28. Thus, for example, first secondary winding 18_1 is electrically connected to an input 25_1 of a first rectifier unit 22_1; that is, first secondary winding 18_1 is associated with first rectifier unit 22_1. Second secondary winding 18_2 is electrically connected to an input 25_2 of a second rectifier unit 22_2, etc. That is, the number of rectifier units 22 is at least as large as the number of secondary windings 18.

A disconnecting switch and/or a grounding switch 24_1 (in particular in the form of a combined disconnecting/grounding means 24_1) is connected between first secondary winding 18_1 and the input 25_1 of first rectifier unit 22_1. This disconnecting switch and/or grounding switch 24_1 is optional and may also be omitted. Disconnecting switch and/or grounding switch 24_1 allow for deenergizing and/or grounding first rectifier unit 22_1 and first electrolysis cell line 5_1 as needed (for example for maintenance or repair).

Output 28_1 of first rectifier unit 22_1 is provided with a capacitor 31_1 for smoothing the direct voltage. Output 28_1 of first rectifier unit 22_1 is electrically connected to first electrolysis cell line 5_1. First rectifier unit 22_1 supplies direct current to first electrolysis cell line 5_1 (and hence electrolysis cell 7_1 to 7_n contained in this line).

A step-up converter 34_1 or a step-down converter 34_1 is connected between output 28_1 of first rectifier unit 22_1 and first electrolysis cell line 5_1. This step-24 up converter 34_1 or step-down converter 34_1 is optional and may also be omitted. Step-up converter 34_1 or step-down converter 34_1 allows to scale the direct voltage applied to electrolysis cell line 5_1 up or down.

First rectifier unit 22_1 has non-controlled power semiconductor elements (for example, diodes) or controlled power semiconductor elements (for example, thyristors, IGBTs or MOSFETs). As such, first rectifier unit 22_1 may form a line-commutated rectifier (then having diodes or thyristors, in particular). However, first rectifier unit 22_1 may also form a self-commutated rectifier, then having IGBTs or MOSFETs, in particular. As the power semiconductor elements, power semiconductor elements based on silicon carbide (SIC) or gallium nitride (GaN) may be employed. However, as the power semiconductor elements, other power semiconductor elements may also be employed, for example power semiconductor elements based on silicon (Si).

In the following, the process of direct current supply to electrolysis cells is explained on the basis of first electrolysis cell line 5_1 as an example. Other electrolysis cell lines 5_2 to 5_m are supplied with direct current in a similar manner.

Primary winding 15 of transformer 9 is connected to an alternating current power supply grid (not shown), for example, to a medium-voltage alternating current power supply grid. Transformer 9 transforms the alternating voltage of the medium-voltage alternating current power supply grid down to a low voltage (for example, to 1 kV); at first secondary winding 18_1, an alternating current of this lower voltage is output. Disconnecting switch 24_1 is closed; the grounding switch is open. The alternating current is conducted to input 25_1 of first rectifier unit 22_1. First rectifier unit 22_1 rectifies the alternating current provided by first secondary winding 18_1 and outputs a direct current at output 28_1. The direct current is optionally smoothened by smoothing capacitor 31_1. The direct current now flows across the step-up converter or step-down converter 34_1 (in which the voltage may be optionally scaled up or down) to first electrolysis cell line 5_1 and supplies electrical energy to electrolysis cells 7_1 to 7_n contained in this line 5_1.

The electrolysis system according to FIG. 1 may be configured with three phases, i.e., first secondary winding 18_1, first rectifier unit 22_1, first electrolysis cell line 5_1, etc. may be configured with three phases.

FIG. 2 shows an exemplary embodiment of an electrolysis system, in which first output 28_1 of first rectifier unit 22_1 and second output 28_2 of second rectifier unit 22_2 are electrically connected in series, thus forming a series circuit. This series circuit of the two outputs 28_1 and 28_2 is connected to first electrolysis cell line 5_1. With the series circuit, the output voltages of first rectifier unit 22_1 and second rectifier unit 22_2 add up so that a greater direct voltage is applied to first electrolysis cell line 5_1. In this way,—compared to the exemplary embodiment of FIG. 1—a greater direct current flows through electrolysis cells 7_1 to 7_n. This allows to provide direct voltages of different magnitudes for an electrolysis cell line using uniform rectifier units as needed. The optional disconnecting switch, grounding switch, step-up converter and/or step-down converter have been omitted in the present and in the following exemplary embodiments but may also be employed.

FIGS. 3 and 4 each show an exemplary embodiment in which first output 28_1 of first rectifier unit 22_1 and second output 28_2 of second rectifier unit 22_2 are electrically connected in parallel and outputs 28_1 and 28_2 connected in parallel are connected to first electrolysis cell line 5_1. With the parallel connection of the outputs of the rectifier units, the output direct currents of first rectifier unit 22_1 and second rectifier unit 22_2 add up so that first electrolysis cell line 5_1 is subject to a greater direct current. In this way,—compared to the exemplary embodiment of FIG. 1—a greater direct current flows through electrolysis cells 7_1 to 7_n. The exemplary embodiments of FIGS. 3 and 4 only differ in the interconnection of the inputs of the rectifier units.

In the exemplary embodiment of FIG. 3, the inputs of the rectifier units are each connected to a dedicated secondary winding. Thus, first input 25_1 of first rectifier unit 22_1 is electrically connected to first secondary winding 18_1; that is, first rectifier unit 22_1 is exclusively supplied with alternating current from first secondary winding 18_1. Second input 25_2 of second rectifier unit 22_2 is electrically connected to second secondary winding 18_2; that is, second rectifier unit 22_2 is exclusively supplied with alternating current from second secondary winding 18_2.

By contrast, in the exemplary embodiment of FIG. 4, the inputs of the rectifier units are connected to a common secondary winding. Thus, first input 25_1 of first rectifier unit 22_1 is electrically connected to first secondary winding 18_1; second input 25_2 of second rectifier unit 22_2 is also electrically connected to first secondary winding 18_1. This means, first rectifier unit 22_1 and second rectifier unit 22_2 are both (exclusively) supplied with alternating current from first secondary winding 18_1. As such, electrical decoupling elements (here: inductors) 403 are arranged at the inputs of the rectifier units to limit the amount of possible transient currents flowing between rectifier units 22_1 and 22_2.

A device for supplying a direct current to electrolysis cells, a method for supplying a direct current to electrolysis cells and an electrolysis system have been described, which are versatile and can be easily adapted to different requirements relating to the direct current to be provided and/or the direct voltage to be provided.

As such, a multi-secondary-winding transformer having a plurality of isolated secondary windings is used. The secondary windings each have a different phase shift relative to the primary winding. In this way, a grid-friendly performance may be implemented, so that comparatively little harmonics occur and hence no or considerably less filters are needed. A plurality of rectifier units enables a modular structure of the device. The device for supplying a direct current may also be referred to as a “multi-rectifier”.

When using self-commutated rectifier units (which may also be operated at higher pulses), a desired power factor (cosine of phase shift angle phi between current and voltage) may be set relating to the supplying alternating current grid, which, in turn, may supersede compensation devices previously required.

The device described for supplying a direct current may be used flexibly and has a finely adaptable and redundant structure. As an example, even if individual rectifier units fail, continued operation is possible, maybe with slightly lower power and slightly poorer grid perturbations.

With the large number of rectifier units, the individual rectifier units may each be operated at a comparatively smaller voltage. In this way, they are able to be manufactured at low cost. For example, inexpensive power semiconductor elements may be employed, in particular those based on silicon carbide (SIC) or gallium nitride (GaN). For example, if the voltage per rectifier unit is not considerably higher than 600V, then, advantageously, power semiconductor elements based on gallium nitride may be used.

The flexibility of possible applications of the device may be increased even further if a series circuit or a parallel circuit of the rectifier units, more specifically, a series circuit or a parallel circuit of the outputs of the rectifier units, is applied.

For example, the device and the method may be applied for proton-exchange membrane (PEM) electrolysis systems, but also for other electrolysis systems. As such, the individual electrolysis cells may be operated at a voltage of approx. 2V, for example. A series circuit of such a large number of electrolysis cells in an electrolysis cell line results in a direct voltage per line of up to one kV and a direct current of several kA, for example. The device described enables high-performance and adjustable direct current supply for such electrolysis systems.

### REFERENCE NUMERALS

1 Electrolysis system
3 Device for supplying a direct current
5 Electrolysis cell line
7 Electrolysis cell
9 Transformer
12 Transformer core
15 Primary winding
18 Secondary winding
22 Rectifier unit
24 Disconnecting switch, grounding switch, combined disconnecting/grounding means
25 Input of the rectifier unit
28 Output of the rectifier unit
31 Capacitor
34 Step-up converter, step-down converter
403 Decoupling element, inductor

1-15. (canceled)

16. A device for supplying a direct current to electrolysis cells, wherein the electrolysis cells are arranged in a plurality of electrolysis cell lines, and each of the electrolysis cell lines has a series circuit formed of multiple electrolysis cells, the device comprising:
a transformer having a primary winding and a plurality of secondary windings;
a plurality of rectifier units each having an input and an output;
wherein each secondary winding of said transformer is electrically connected to a respective input of one of said rectifier units; and
wherein said output of each of said rectifier units is electrically connected to a respective one of the electrolysis cell lines.

17. The device according to claim 16, wherein said secondary windings are galvanically isolated from one another.

18. The device according to claim 16, wherein each secondary winding is associated with a rectifier unit.

19. The device according to claim 16, wherein said transformer has at least four secondary windings.

20. The device according to claim 19, wherein said transformer has at least ten secondary windings.

21. The device according to claim 16, wherein each of said secondary windings has substantially a secondary voltage of the same amplitude.

22. The device according to claim 16, wherein each of said secondary windings has a different phase shift relative to said primary winding.

23. The device according to claim 16, wherein each of said rectifier units has non-controlled or controlled power semiconductor elements.

24. The device according to claim 23, wherein said power semiconductor elements are selected from the group consisting of diodes, thyristors, IGBTs, and MOSFETs.

25. The device according to claim 23, wherein said power semiconductor elements are power semiconductor elements based on silicon carbide or gallium nitride.

26. The device according to claim 16, which further comprises a step-up converter or a step-down converter connected between said output of at least one of said rectifier units and the respective electrolysis cell line.

27. The device according to claim 26, wherein said step-up converter or step-down converter is connected between said output of each of said rectifier units and the respective electrolysis cell line.

28. The device according to claim 16, which further comprises at least one of a disconnecting switch or a grounding switch connected between at least one of said secondary windings and the respective input of said rectifier unit.

29. The device according to claim 28, wherein a respective said disconnecting switch or grounding switch is connected between each of said secondary windings and the respective said input of said rectifier unit.

30. The device according to claim 16, wherein said outputs of a plurality of said rectifier units are connected in parallel, and said parallel-connected outputs are connected to an electrolysis cell line.

31. The device according to claim 16, wherein said outputs of a plurality of said rectifier units are connected in a series circuit, and said series circuit is connected to an electrolysis cell line.

32. An electrolysis system, comprising:
a device according to claim 16 for supplying a direct current;
a plurality of electrolysis cells arranged in multiple electrolysis cell lines, with each electrolysis cell line having a series circuit formed of multiple electrolysis cells; and
each of said electrolysis cell lines being electrically connected to an output of one of the rectifier units.

33. A method for supplying a direct current to electrolysis cells, the method comprising:
providing the electrolysis cells arranged in multiple electrolysis cell lines each having a series circuit formed of multiple electrolysis cells;
providing a transformer with a primary winding and a number of secondary windings;
providing a number of rectifier units and electrically connecting each secondary winding of the transformer to an input of one of the rectifier units; and
supplying each of the electrolysis cell lines with a direct current from a respective output of one of the rectifier units.

34. The method according to claim 33, which comprises supplying with each of the secondary windings of the transformer a secondary voltage of a same amplitude.
